(19) United States
(12) Patent Application Publication
(10) Pub. No.: US 2026/0275078 A1
(43) Pub. Date: Sep. 17, 2026

(54) IONOMER

(71) Applicant: TOYOTA JIDOSHA KABUSHIKI KAISHA, Toyota-shi (JP)

(72) Inventors: Misato KON, Toyota-shi (JP); Keiichi Okubo, Toyota-shi (JP)

(73) Assignee: TOYOTA JIDOSHA KABUSHIKI KAISHA, Toyota-shi (JP)

(21) Appl. No.: 19/560,476

(22) Filed: Mar. 9, 2026

(30) Foreign Application Priority Data
Mar. 13, 2025 (JP) 2025-040234

(51) Int. Cl. C08K 5/3492; H01M 4/86

(52) U.S. Cl. CPC C08K 5/34922; H01M 4/8668

(57) ABSTRACT

One aspect of the present disclosure relates to an ionomer including acidic functional groups and a modifying layer that modifies the acidic functional groups. The modifying layer contains a nitrogen-containing cyclic organic compound, a polymer of the nitrogen-containing cyclic organic compound, or a cation of the nitrogen-containing cyclic organic compound or the polymer. Equivalent mass of the acidic functional groups is 1000 g/eq or less.

### CROSS-REFERENCE TO RELATED APPLICATION

This application claims priority to Japanese Patent Application No. 2025-040234 filed on Mar. 13, 2025. The disclosure of the above-identified application, including the specification, drawings, and claims, is incorporated by reference herein in its entirety.

### BACKGROUND

### 1. Technical Field

The present disclosure relates to an ionomer.

### 2. Description of Related Art

Fuel cells generate electric power by electrochemically reacting hydrogen and oxygen. In principle, the only product obtained during power generation in fuel cells is water. Therefore, fuel cells are attracting attention as a clean power generation system that places substantially no loads on the global environment. A fuel cell is constructed using, as its basic unit, a membrane electrode assembly (hereinafter also referred to as “MEA”) in which electrode catalyst layers are disposed on both sides of an electrolyte membrane and gas diffusion layers are disposed outward of the electrode catalyst layers. During operation of the fuel cell, an electromotive force is generated by supplying a fuel gas containing hydrogen to the electrode catalyst layer on an anode (fuel electrode) side and an oxidizing gas containing oxygen to the electrode catalyst layer on a cathode (air electrode) side. Oxidation reaction of hydrogen occurs at the anode, and reduction reaction of oxygen occurs at the cathode, thereby supplying the electromotive force to an external circuit. For this reason, an oxygen reduction catalyst having oxygen reduction ability is used in the cathode electrode catalyst layer. A polymer electrolyte having an ion exchange group (hereinafter also referred to as “ionomer”) is typically used for the binder of the electrode catalyst layer and the electrolyte membrane.

For example, Japanese Unexamined Patent Application Publication No. 2021-161154 (JP 2021-161154 A) describes an ionomer containing an acidic group-containing polymer and a basic group-containing metal complex.

Unpublished Japanese Patent Application No. 2024-081009 describes an ionomer including an acidic functional group and a modifying layer that modifies the acidic functional group. The modifying layer contains a nitrogen-containing cyclic organic compound, a polymer thereof, or a cation thereof. The content of the nitrogen-containing cyclic organic compound, the polymer thereof, or the cation thereof is 120 mol % or less with respect to the total substance amount of the acidic functional group.

### SUMMARY

There have been developed various ionomers that can be used in the electrode catalyst layers of fuel cells as described above. In the electrode catalyst layer of the fuel cell, particularly in the cathode electrode catalyst layer, it is necessary to smoothly supply protons and oxygen to the electrode catalyst. Ionomers typically have acidic ion exchange groups, which can contribute to proton transport but can also inhibit oxygen transport. Therefore, there is room for improvement in gas diffusibility of the ionomers of the related art.

Japanese Patent Application No. 2024-081009 describes the ionomer in which the gas diffusibility is improved by using the modifying layer containing the nitrogen-containing cyclic organic compound, the polymer thereof, or the cation thereof in a predetermined content as the modifying layer that modifies the acidic functional group of the ionomer. However, an MEA including an electrochemical oxygen reduction catalyst containing an ionomer including a modifying layer containing a nitrogen-containing cyclic organic compound, a polymer thereof, or a cation thereof has a problem in that the proton conductivity decreases particularly under a low humidification condition.

Therefore, an object of the present disclosure is to provide an ionomer having both high gas diffusibility and high proton conductivity.

The inventors studied various means for solving the above problem. The inventors have found that both the gas diffusibility and the proton conductivity of an ionomer are improved by using an ionomer including acidic functional groups having equivalent mass of a predetermined value or less and using a modifying layer containing a nitrogen-containing cyclic organic compound, a polymer thereof, or a cation thereof in a predetermined content as a modifying layer that modifies the acidic functional groups of the ionomer. The inventors completed the present disclosure based on the above findings.

That is, the present disclosure includes the following aspects and embodiments.

### First Embodiment

An ionomer including acidic functional groups and a modifying layer that modifies the acidic functional groups, in which
the modifying layer contains a nitrogen-containing cyclic organic compound, a polymer of the nitrogen-containing cyclic organic compound, or a cation of the nitrogen-containing cyclic organic compound or the polymer, and
equivalent mass of the acidic functional groups is 1000 g/eq or less.

### Second Embodiment

The ionomer according to the first embodiment, in which the nitrogen-containing cyclic organic compound, the polymer of the nitrogen-containing cyclic organic compound, or the cation of the nitrogen-containing cyclic organic compound or the polymer is melamine, ammeline, ammelide, cyanuric acid, triazine, a derivative of the melamine, the ammeline, the ammelide, the cyanuric acid, or the triazine, a polymer of the melamine, the ammeline, the ammelide, the cyanuric acid, or the triazine, or a cation of the melamine, the ammeline, the ammelide, the cyanuric acid, the triazine, the derivative, or the polymer.

### Third Embodiment

The ionomer according to the first or second embodiment, in which the nitrogen-containing cyclic organic compound, the polymer of the nitrogen-containing cyclic organic compound, or the cation of the nitrogen-containing cyclic organic compound or the polymer is melamine.

### Fourth Embodiment

The ionomer according to any one of the first to third embodiments, in which the acidic functional groups are bonded via a long-chain hydrocarbon group.

### Fifth Embodiment

The ionomer according to any one of the first to fourth embodiments, in which the equivalent mass of the acidic functional groups is in a range of 550 g/eq to 900 g/eq.

According to the present disclosure, it is possible to provide the ionomer having both high gas diffusibility and high proton conductivity.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows the relationship between the equivalent mass of each of ionomers of examples and comparative examples and the H⁺ transport resistance under a low humidification condition for each of MEAs including electrochemical oxygen reduction catalysts containing the ionomers, in which the horizontal axis represents the equivalent mass (g/eq) of the ionomer, the vertical axis represents the H⁺ transport resistance (−) under the low humidification condition, “◯” represents the values of Comparative Examples 1 to 5, “●” represents the values of Examples 1 to 4, and the H⁺ transport resistance (−) under the low humidification condition is shown as a relative value with the value of Comparative Example 1 set to 1.00; and

FIG. 2 shows the relationship between the equivalent mass of each of the ionomers of the examples and the comparative examples and the gas diffusion resistance of each of the MEAs including the electrochemical oxygen reduction catalysts containing the ionomers, in which the horizontal axis represents the equivalent mass (g/eq) of the ionomer, the vertical axis represents the gas diffusion resistance (−), “◯” represents the values of Comparative Examples 1 to 5, “●” represents the values of Examples 1 to 4, and the gas diffusion resistance (−) is shown as a relative value with the value of Comparative Example 1 set to 1.00.

### DETAILED DESCRIPTION OF EMBODIMENTS

Hereinafter, a preferred embodiment of the present disclosure will be described in detail.

### 1: Ionomer

One aspect of the present disclosure relates to an ionomer. The ionomer of the present aspect includes an acidic functional group and a modifying layer that modifies the acidic functional group.

Examples of the polymer constituting the ionomer of the present aspect include polymers containing perfluorocarbon, polyether ether ketone, and polybenzimidazole as main components. The polymer constituting the ionomer of the present aspect is preferably perfluorocarbon. With the polymer exemplified above, the ionomer of the present aspect can exhibit high proton conductivity.

In the ionomer of the present aspect, examples of the acidic functional group include a sulfonic acid group and a phosphoric acid group. The acidic functional group is preferably the sulfonic acid group. With the acidic functional group exemplified above, the ionomer of the present aspect can exhibit high proton conductivity.

The ionomer of the present aspect preferably has a structure in which the acidic functional groups exemplified above are bonded via a long-chain hydrocarbon group, and more preferably has a structure in which the acidic functional groups exemplified above are bonded via a fluorine-substituted long-chain hydrocarbon group. With the structure exemplified above, the ionomer of the present aspect can exhibit high proton conductivity.

In the ionomer of the present aspect, the structures of the polymer and the acidic functional group that are the constituent elements can be determined, for example, by analyzing the ionomer of the present aspect by elemental analysis, various types of chromatography, ultraviolet-visible spectroscopy (UV-Vis), infrared spectroscopy (IR), or nuclear magnetic resonance (NMR).

In the ionomer of the present aspect, the modifying layer contains a nitrogen-containing cyclic organic compound, a polymer thereof, or a cation thereof. The component may interact with the acidic functional group and/or the polymer constituting the ionomer. For example, the component typically forms a complex, particularly an ionic bond, with the acidic functional group modified by the modifying layer. In related-art ionomers without the modifying layer, the polymer constituting the ionomer typically has high crystallinity, which may inhibit oxygen transport within the ionomer. In related art ionomers, the polymer constituting the ionomer is typically highly adsorbent to an electrode catalyst, which may inhibit oxygen transport at the interface between the ionomer and the electrode catalyst. In the ionomer of the present aspect, the nitrogen-containing cyclic organic compound, the polymer thereof, or the cation thereof contained in the modifying layer interacts with the acidic functional group and/or the polymer constituting the ionomer to optimize the crystallinity of the polymer and/or its adsorption to the electrode catalyst, thereby improving gas diffusibility of oxygen etc. With the modifying layer containing the component exemplified above, the ionomer of the present aspect can exhibit high gas diffusibility.

In each aspect of the present disclosure, the nitrogen-containing cyclic organic compound, the polymer thereof, or the cation thereof means a compound containing a nitrogen atom in a ring member and/or a ring-bonding group of a monocyclic or polycyclic organic compound, a polymer thereof, or a cation thereof. The nitrogen equivalent weight of the nitrogen-containing cyclic organic compound is typically in a range of 20 g/eq to 270 g/eq, particularly in a range of 20 g/eq to 70 g/eq. The nitrogen equivalent weight of the nitrogen-containing cyclic organic compound is defined by the following formula: nitrogen equivalent weight (g/eq)=molecular weight of nitrogen-containing organic compound (g/mol)/substance amount of nitrogen atoms contained in one molecule of nitrogen-containing organic compound (molN/mol). In the case of the polymer of the nitrogen-containing cyclic organic compound, the nitrogen equivalent weight of the monomer contained in the polymer may be in the range exemplified above.

The number of nitrogen atoms in the nitrogen-containing cyclic organic compound is not particularly limited. For example, the number of nitrogen atoms in the nitrogen-containing cyclic organic compound is preferably 3 or more, and more preferably in a range of 3 to 6, as the total number of basic nitrogen atoms. The number of nitrogen atoms in the nitrogen-containing cyclic organic compound is preferably 3 or less, and more preferably in a range of 0 to 3, as the total number of nitrogen atoms in the ring-bonding group.

Examples of the nitrogen-containing cyclic organic compound include pyridine, pyrrole, thiazole, isothiazole, oxazole, isoxazole, imidazole, imidazoline, pyrazole, 1,3,5-triazine, pyrimidine, pyritazine, pyrazine, indole, quinoline, isoquinoline, purine, benzimidazole, benzoxazole, benzthiazole, tetrazole, tetrazine, triazole, carbazole, acridine, quinoxaline, and quinazoline. The nitrogen-containing cyclic organic compounds exemplified above may include, as the ring-bonding group, one or more substituted or unsubstituted amines or aminos (e.g., a primary amine, a secondary amine, a tertiary amine, or a quaternary ammonium cation), a hydroxyl, a halogen (e.g., fluorine, chlorine, bromine, or iodine), a nitrile, an amide, an imide, a thiol, a sulfonyl, a carboxyl, a phosphonyl, a ketone, an aldehyde, an ester, a substituted or unsubstituted alkyl, a substituted or unsubstituted alkenyl, a substituted or unsubstituted alkynyl, a substituted or unsubstituted cycloalkyl, a substituted or unsubstituted cycloalkenyl, a substituted or unsubstituted cycloalkynyl, a substituted or unsubstituted heterocycloalkyl, a substituted or unsubstituted cycloalkylalkyl, a substituted or unsubstituted heterocycloalkylalkyl, a substituted or unsubstituted aryl, a substituted or unsubstituted arylalkyl, a substituted or unsubstituted heteroaryl, a substituted or unsubstituted heteroarylalkyl, a substituted or unsubstituted alkoxy, a substituted or unsubstituted cycloalkoxy, a substituted or unsubstituted heterocycloalkoxy, a substituted or unsubstituted aryloxy, a substituted or unsubstituted arylalkyloxy, a substituted or unsubstituted arylalkenyloxy, a substituted or unsubstituted heteroaryloxy, a substituted or unsubstituted heteroarylalkyloxy, or a substituted or unsubstituted acyloxy. The number of carbon atoms in the groups exemplified above is typically in a range of 1 to 10 when they are chained, and typically in a range of 3 to 16 when they are cyclic. When the groups exemplified above are substituted, the substituents are preferably one or more groups selected from the groups exemplified above.

The nitrogen-containing cyclic organic compound, the polymer thereof, or the cation thereof is preferably melamine (1,3,5-triazine-2,4,6-triamine), ammeline, ammelide, cyanuric acid, triazine (1,2,3-triazine, 1,2,4-triazine, or 1,3,5-triazine), a derivative thereof, a polymer thereof, or a cation thereof, more preferably melamine or a derivative thereof (nitrogen equivalent weight of 21 g/eq), ammeline, ammelide, 1,3,5-triazine or a derivative thereof (nitrogen equivalent weight of 27 g/eq), thiocyanuric acid or a derivative thereof (nitrogen equivalent weight of 59 g/eq), cyanuric acid or a derivative thereof (nitrogen equivalent weight of 34 g/eq), oleylamine or a derivative thereof (nitrogen equivalent weight of 267 g/eq), tetradecylamine or a derivative thereof (nitrogen equivalent weight of 213 g/eq), 2,4,6-tris[bis(methoxymethyl)amino]-1,3,5-triazine (nitrogen equivalent weight of 65 g/eq), 6-(dibutylamino)-1,3,5-triazine-2,4-dithiol (nitrogen equivalent weight of 68 g/eq), 2,4-diamino-6-butylamino-1,3,5-triazine (nitrogen equivalent weight of 30 g/eq), 2,4,6-tris(pentafluoroethyl)-1,3,5-triazine (nitrogen equivalent weight of 145 g/eq), polymers of these monomers, copolymers such as melamine-formaldehyde copolymers typified by methylated poly(melamine-co-formaldehyde) (nitrogen equivalent weight of 20 g/eq to 40 g/eq) or isobutylated poly(melamine-co-formaldehyde) (nitrogen equivalent weight of 20 g/eq to 40 g/eq), or cations thereof, and even more preferably melamine.

Examples of the polymer of the nitrogen-containing cyclic organic compound include a homopolymer or copolymer containing at least one of the nitrogen-containing cyclic organic compounds exemplified above as a monomer. In the case of the polymer of the nitrogen-containing cyclic organic compound, the degree of polymerization is preferably in a range of 1 to 10000, and more preferably in a range of 10 to 10000.

The content of the nitrogen-containing cyclic organic compound, the polymer thereof, or the cation thereof is typically 120 mol % or less with respect to the total substance amount of the acidic functional group. The content of the nitrogen-containing cyclic organic compound, the polymer thereof, or the cation thereof is preferably in a range of 1 mol % to 120 mol %, and more preferably in a range of 10 mol % to 80 mol % with respect to the total substance amount of the acidic functional group. The content of the nitrogen-containing cyclic organic compound, the polymer thereof, or the cation thereof is preferably 10 mass % or less, more preferably in a range of 0.1 mass % to 10 mass %, and even more preferably in a range of 1 mass % to 10 mass % with respect to the total mass of the ionomer of the present aspect. When the content of the nitrogen-containing cyclic organic compound, the polymer thereof, or the cation thereof is less than the lower limit, there is a possibility that the desired effect is not exhibited. When the content of the nitrogen-containing cyclic organic compound, the polymer thereof, or the cation thereof is more than the upper limit, the gas diffusibility and/or the proton conductivity may decrease. Therefore, when the modifying layer contains the nitrogen-containing cyclic organic compound, the polymer thereof, or the cation thereof in the content exemplified above, the ionomer of the present aspect can achieve both high gas diffusibility and high proton conductivity.

In the ionomer of the present aspect, the composition and content of the nitrogen-containing cyclic organic compound, the polymer thereof, or the cation thereof contained in the modifying layer can be determined, for example, by dissolving and extracting the modifying layer contained in the ionomer of the present aspect and analyzing the components contained in the extract by elemental analysis, various types of chromatography, UV-Vis, IR, or NMR.

It has been found that, when the equivalent mass (hereinafter also referred to as “equivalent weight (EW)”) of the acidic functional groups exemplified above is 1000 g/eq or less, the ionomer of the present aspect has significantly higher proton conductivity than a control ionomer including the same modified layer but having higher EW. Therefore, in the ionomer of the present aspect, the EW of the acidic functional group is 1000 g/eq or less, preferably in a range of 500 g/eq to 1000 g/eq, more preferably in a range of 500 g/eq to 900 g/eq, even more preferably in a range of 550 g/eq to 900 g/eq, and particularly preferably in a range of 550 g/eq to 720 g/eq. When the EW of the acidic functional group is more than the upper limit, the proton conductivity may decrease. When the EW of the acidic functional group is less than the lower limit, the crystallinity of the polymer decreases and the elution into water increases. Therefore, there is a possibility that a stable structure cannot be maintained over a long period. Thus, the ionomer of the present aspect in which the EW of the acidic functional group is in the range exemplified above can achieve both high gas diffusibility and high proton conductivity.

In the ionomer of the present aspect, the EW of the acidic functional group can be determined, for example, by measuring the dry mass of the ionomer of the present aspect and measuring the equivalent weight of the acidic functional group contained in a predetermined dry mass of the ionomer by acid-base titration.

With the above features, the ionomer of the present aspect can achieve both high gas diffusibility and high proton conductivity.

The gas diffusibility of the ionomer of the present aspect can be evaluated, for example, by preparing an electrochemical oxygen reduction catalyst using the ionomer as a binder, producing an MEA using the electrochemical oxygen reduction catalyst at a cathode, and measuring the gas diffusion resistance (e.g., oxygen diffusion resistance) in an electrode catalyst layer of the MEA.

The proton conductivity of the ionomer of the present aspect can be evaluated, for example, by preparing an electrochemical oxygen reduction catalyst using the ionomer as a binder, producing an MEA using the electrochemical oxygen reduction catalyst at a cathode, and measuring the current-voltage characteristics (e.g., proton transport resistance in an electrode catalyst layer or cell voltage at a predetermined current density) of the MEA under a low humidification condition (e.g., 30% RH) and a high humidification condition (e.g., 80% RH).

### 2: Electrochemical Oxygen Reduction Catalyst

Another aspect of the present disclosure relates to an electrochemical oxygen reduction catalyst. The electrochemical oxygen reduction catalyst of the present aspect includes a catalytic metal having oxygen reduction activity and a binder containing the ionomer of the one aspect of the present disclosure.

In the electrochemical oxygen reduction catalyst of the present aspect, the catalytic metal may be any metal having oxygen reduction activity (oxygen reduction catalytic ability). Examples of the catalytic metal include platinum, ruthenium, iridium, rhodium, palladium, osmium, tungsten, lead, iron, chromium, cobalt, nickel, manganese, vanadium, molybdenum, gallium, aluminum, lanthanum, cerium, praseodymium, neodymium, samarium, gadolinium, and yttrium. The catalytic metal may contain any one of the metals exemplified above alone or an alloy of two or more of them. The catalytic metal may be an oxide, nitride, sulfide, or phosphide of the metals exemplified above. The catalytic metal is preferably platinum, a platinum alloy, or a composite containing platinum. In the case of a platinum alloy and a composite containing platinum, examples of metals other than platinum include ruthenium, iridium, rhodium, palladium, osmium, tungsten, lead, iron, chromium, cobalt, nickel, manganese, vanadium, molybdenum, gallium, aluminum, lanthanum, cerium, praseodymium, neodymium, samarium, gadolinium, and yttrium. The platinum alloy and the composite containing platinum may contain two or more of the metals exemplified above. By containing the catalytic metals exemplified above, the electrochemical oxygen reduction catalyst of the present aspect can exhibit high catalytic activity.

The content of the catalytic metal is typically in a range of 1 mass % to 70 mass %, for example, in a range of 48 mass % to 50 mass %, and particularly in a range of 18 mass % to 50 mass % with respect to the total mass of the electrochemical oxygen reduction catalyst of the present aspect. When the catalytic metal is a platinum alloy or a composite containing platinum, the content of metals other than platinum is typically in a range of 0.11 atomic % to 60 atomic % with respect to the total mass of the catalytic metal. By containing the catalytic metal in the content within the above range, the electrochemical oxygen reduction catalyst of the present aspect can exhibit high catalytic activity.

The particle size of the catalytic metal is typically in a range of 1 nm to 100 nm.

In the electrochemical oxygen reduction catalyst of the present aspect, the composition and content of the catalytic metal can be determined, for example, by dissolving and extracting the catalytic metal contained in the electrochemical oxygen reduction catalyst of the present aspect and analyzing the metal elements contained in the extract by thermogravimetric analysis (IG) or inductively coupled plasma optical emission spectroscopy (ICP).

In the electrochemical oxygen reduction catalyst of the present aspect, the particle size of the catalytic metal can be determined, for example, by measuring crystallite sizes by X-ray diffraction and calculating an average crystallite size. Alternatively, the particle size of the catalytic metal may be determined by measuring the particle sizes of 100 to 1000 catalytic metal particles using an electron microscope and calculating an average value (average particle size) of them.

The electrochemical oxygen reduction catalyst of the present aspect typically includes a support that supports the catalytic metal. Examples of the support include conductive carbon and oxides, and mixtures of one or more of them. The carbon is preferably carbon black (such as acetylene black, ketjen black, or furnace black), activated carbon, graphite, glassy carbon, graphene, carbon fibers, carbon nanotubes, carbon nitride, sulfurized carbon, phosphorus-doped carbon, channel black, roller black, disc black, oil furnace black, gas furnace black, lamp black, thermal black, Vulcan carbon, or a mixture of one or more of them. The oxide is preferably titanium oxide, niobium oxide, tin oxide, tungsten oxide, molybdenum oxide, or a mixture of one or more of them. The support is preferably carbon, and more preferably carbon black.

The support may be either primary particles or secondary particles. The particle size of the primary particles of the support is typically in a range of 5 nm to 5000 nm.

In the electrochemical oxygen reduction catalyst of the present aspect, the composition, content, and particle size of the support can be determined, for example, by the same methods as those for determining the composition, content, and particle size of the catalytic metal described above.

With the above features, the electrochemical oxygen reduction catalyst of the present aspect can achieve both high gas diffusibility and high proton conductivity.

The gas diffusibility and the proton conductivity of the electrochemical oxygen reduction catalyst of the present aspect can be evaluated by the same methods as those for evaluating the gas diffusibility and the proton conductivity of the ionomer of the one aspect of the present disclosure.

### 3: Application of Ionomer

Another aspect of the present disclosure relates to a fuel cell. The fuel cell of the present aspect includes at least a cathode electrode catalyst layer, an anode electrode catalyst layer, and an electrolyte membrane disposed between the cathode electrode catalyst layer and the anode electrode catalyst layer. The cathode electrode catalyst layer contains an electrochemical oxygen reduction catalyst and the ionomer of the one aspect of the present disclosure.

Still another aspect of the present disclosure relates to a water electrolysis system. The water electrolysis system of the present aspect includes at least a cathode electrode catalyst layer, an anode electrode catalyst layer, an electrolyte membrane disposed between the cathode electrode catalyst layer and the anode electrode catalyst layer, and a water supply unit. The anode electrode catalyst layer contains an electrochemical oxygen reduction catalyst and the ionomer of the one aspect of the present disclosure.

Yet another aspect of the present disclosure relates to a metal-air battery. The metal-air battery of the present aspect includes at least a cathode electrode catalyst layer, an anode metal layer, and an electrolyte membrane disposed between the cathode electrode catalyst layer and the anode metal layer. The cathode electrode catalyst layer contains an electrochemical oxygen reduction catalyst and the ionomer of the one aspect of the present disclosure.

The fuel cell, the water electrolysis system, and the metal-air battery of the present aspects can achieve both high gas diffusibility and high proton conductivity by including the ionomer of the one aspect of the present disclosure in the cathode or anode electrode catalyst layer. Therefore, the fuel cell of the present aspect can be applied as a fuel cell for powering moving bodies such as automobiles, trains, ships, and aircraft, or as a power source for home or commercial use.

### 4: Method for Producing Ionomer

Another aspect of the present disclosure relates to a method for producing the ionomer of the one aspect of the present disclosure. The method of the present aspect includes a modification step. The method of the present aspect may optionally include a preparation step, an electrode catalyst preparing step, and an electrode catalyst layer producing step.

### 4-1: Preparation Step

This step includes preparing an ionomer material including an acidic functional group (hereinafter also simply referred to as “ionomer material”) and a modifier. The step typically also includes preparing a catalytic metal, a support, and a binder. The step may further optionally include preparing additional materials such as a solvent and a substrate.

The ionomer material, the catalytic metal, the support, and the binder prepared in this step may be any materials having the features described above. For example, the catalytic metal prepared in this step may be in a form in which it is supported on the support described above.

The modifier prepared in this step contains at least a cation of a nitrogen-containing cyclic organic compound or a polymer thereof. The cation of the nitrogen-containing cyclic organic compound or the polymer thereof contained in the modifier may be any material having the features described above.

In this step, each material may be prepared by self-preparing one having predetermined features, or may be prepared by purchasing a commercially available product.

### 4-2: Modification Step

This step includes mixing the ionomer material including the acidic functional group with the modifier to modify the acidic functional group.

In this step, the ionomer material including the acidic functional group and the modifier are typically mixed together with a solvent. The solvent is not particularly limited, and any liquid can be used. Examples of the solvent include water and alcohols, and mixtures of one or more of them. Examples of the alcohols include methanol, ethanol, 1-propanol, 2-propanol, 2-methyl-2-propanol (tert-butyl alcohol), diacetone alcohol, ethylene glycol, and propylene glycol.

In this step, the means for mixing the materials is not particularly limited. Examples of the mixing means include an ultrasonic homogenizer, a jet mill, a bead mill, a ball mill, a high-shear mill, and a Filmix. The specific conditions for the mixing means exemplified above (e.g., stirring speed, stirring time, and rotation speed) are not particularly limited and can be set as appropriate in any range.

This step may optionally include vacuum degassing treatment in which the obtained mixture is degassed under a vacuum condition. In this case, the specific conditions for the vacuum degassing treatment (e.g., pressure and treatment time) are not particularly limited and can be set as appropriate in any range. The vacuum degassing treatment may be performed multiple times.

In this step, the solvent is removed from the obtained mixture, thereby obtaining an electrochemical oxygen reduction catalyst containing the ionomer of the one aspect of the present disclosure. The removal of the solvent is not particularly limited, and can be performed by any method such as heat drying or filtration.

By performing this step, the acidic functional group of the ionomer material can be modified by the modifying layer containing the nitrogen-containing cyclic organic compound, the polymer thereof, or the cation thereof.

### 4-3: Electrode Catalyst Preparing Step

This step includes mixing a catalytic metal with a binder to prepare an electrode catalyst. The binder used in this step includes the ionomer including the modifying layer prepared in the above step.

In this step, the catalytic metal and the binder are typically mixed together with a solvent. The solvent may be the same solvent as that used in the modification step described above. The means for mixing the materials may be the same mixing means as that used in the modification step described above.

This step may optionally include vacuum degassing treatment in which the obtained mixture is degassed under a vacuum condition. In this case, the specific conditions for the vacuum degassing treatment (e.g., pressure and treatment time) are not particularly limited and can be set as appropriate in any range. The vacuum degassing treatment may be performed multiple times.

In this step, the solvent is removed from the obtained mixture, thereby obtaining an electrochemical oxygen reduction catalyst containing the ionomer of the one aspect of the present disclosure. The removal of the solvent is not particularly limited, and can be performed by any method such as heat drying or filtration.

Alternatively, when the electrode catalyst layer producing step described below is performed, the mixture obtained in this step can be used in the electrode catalyst layer producing step as catalyst ink containing the electrochemical oxygen reduction catalyst containing the ionomer of the one aspect of the present disclosure. In this case, the mixture obtained in this step may be used as it is, or may be used after further adding the solvent exemplified above.

By performing this step, the electrochemical oxygen reduction catalyst containing the ionomer of the one aspect of the present disclosure can be obtained.

### 4-4: Electrode Catalyst Layer Producing Step

This step includes applying the catalyst ink containing the electrochemical oxygen reduction catalyst obtained in the electrode catalyst preparing step onto the surface of a substrate.

The substrate used in this step is not particularly limited, and any material such as polytetrafluoroethylene (PTFE), an electrolyte membrane having an ion exchange group, carbon fibers, or metal fibers can be used.

In this step, the method for applying the catalyst ink is not particularly limited. Examples of the application method include die coating, spin coating, screen printing, doctor blade coating, squeegee coating, spray coating, and applicator coating. The specific conditions for the application method exemplified above are not particularly limited and can be set as appropriate in any range.

In this step, the solvent is typically removed from the applied catalyst ink. The removal of the solvent is not particularly limited, and can be performed by any method such as heat drying. The specific conditions for the removal of the solvent (e.g., temperature, pressure, and treatment time) are not particularly limited and can be set as appropriate in any range.

By performing this step, the electrochemical oxygen reduction catalyst containing the ionomer of the one aspect of the present disclosure can be obtained in a form in which it is disposed on the surface of the substrate (electrode catalyst layer).

By performing the method of the present aspect as described above, it is possible to produce the ionomer of the one aspect of the present disclosure and the electrochemical oxygen reduction catalyst containing the ionomer.

As described in detail herein, the ionomer of the one aspect of the present disclosure and the electrochemical oxygen reduction catalyst containing the ionomer can achieve both high gas diffusibility and high proton conductivity. The production method of the one aspect of the present disclosure can efficiently provide the ionomer of the one aspect of the present disclosure that has high gas diffusibility and high proton conductivity, and the electrochemical oxygen reduction catalyst containing the ionomer. Therefore, it is possible to provide a fuel cell having both high gas diffusibility and high proton conductivity by applying the electrochemical oxygen reduction catalyst containing the ionomer of the one aspect of the present disclosure to, for example, the cathode of the fuel cell. Such a fuel cell can be suitably used as a fuel cell for powering moving bodies such as automobiles, trains, ships, and aircraft, or as a power source for home or commercial use.

Hereinafter, the present disclosure will be described in more detail using examples. However, the technical scope of the present disclosure is not limited to these examples.

### I: Production of Ionomer

### I-1: Preparation of Ionomer

As the ionomer material, a perfluorocarbon sulfonic acid polymer having a molecular structure defined by Nafion (produced by Chemours) or Aquivion (produced by Solvay) and having a predetermined equivalent mass (EW) was prepared. Melamine was prepared as a nitrogen-containing cyclic organic compound, a polymer thereof, or a cation thereof. A modifier containing a predetermined amount of the nitrogen-containing cyclic organic compound, the polymer thereof, or the cation thereof was prepared such that the amount was 10 mol % with respect to the total substance amount (mol) of the acidic functional group in the ionomer material having the acidic functional group. The ionomer material, the modifier, and a solvent (water) were placed in a container in predetermined amounts. These materials were stirred and mixed for 15 minutes or more using an ultrasonic homogenizer and a stirrer to prepare an ionomer including a modifying layer (modification step).

As Comparative Examples 1 to 4, control ionomers without the modifying layer were prepared by the same procedure as the above, except that no modifier was added. As Comparative Example 5, a control ionomer including the modifying layer was prepared by the same procedure as the above, except that a related-art ionomer material having an EW of 1100 was used.

### II: Production of Electrochemical Oxygen Reduction Catalyst

### II-1: Preparation of Catalyst Ink

A catalytic metal particle support (primary particle size: 10 nm to 100 nm) that is a support (acetylene black) that supports platinum particles (particle size: 3 nm to 4 nm), a binder containing the ionomer prepared by the above procedure, and a solvent (water) were placed in a container in predetermined amounts. These materials were mixed and stirred using a stirrer (homogenizer and Filmix) to prepare catalyst ink containing an electrochemical oxygen reduction catalyst (modification step). The content of the platinum particles in the electrochemical oxygen reduction catalyst was 48 mass % to 50 mass % with respect to the total mass of the catalyst.

### II-2: Production of Catalyst Layer

The prepared catalyst ink was applied onto a substrate (plate made of polytetrafluoroethylene (PTFE)) using a homogenizer and a Filmix. The applied catalyst ink was heated to dry and remove the solvent (catalyst ink applying step). The obtained catalyst layer had a thickness of 5 m to 30 m and a platinum support amount of 0.1 mg/cm² to 0.6 mg/cm².

### II-3: Production of Membrane Electrode Assembly

Each catalyst layer produced by the above procedure was prepared as a cathode catalyst layer, a perfluorocarbon sulfonic acid polymer (Nafion NR211 produced by Chemours, EW: 1100) was prepared as an electrolyte membrane, and a platinum-supported carbon catalyst (TEC10E50E produced by Tanaka Kikinzoku Kogyo) was prepared as an anode catalyst layer. The electrolyte membrane was sandwiched between the cathode catalyst layer and the anode catalyst layer. The cathode catalyst layer, the electrolyte membrane, and the anode catalyst layer were subjected to thermocompression bonding under conditions of heating (130° C.) and pressurization (3 MPa). Gas diffusion layers made of carbon fibers (GDL 22 BB produced by SGL Carbon) were disposed outward of the cathode catalyst layer and the anode catalyst layer to produce a membrane electrode assembly (MEA) (electrode part: 1×1 cm).

### III: Performance Evaluation for Electrochemical Oxygen Reduction Catalyst

### III-1: Electrochemical Performance Evaluation for Membrane Electrode Assembly

The MEA produced by the above procedure was used as a single cell to measure the current-voltage characteristics under a low humidification condition (30% RH) and a high humidification condition (80% RH). The measurement conditions are as follows. Sweep rate: 20 mA/s (anodic sweep), cell temperature: 80° C., pressure: 150 kPa_abs, cathode gas type: air, cathode gas flow rate: 2.0 L/min

### III-2: Evaluation Results

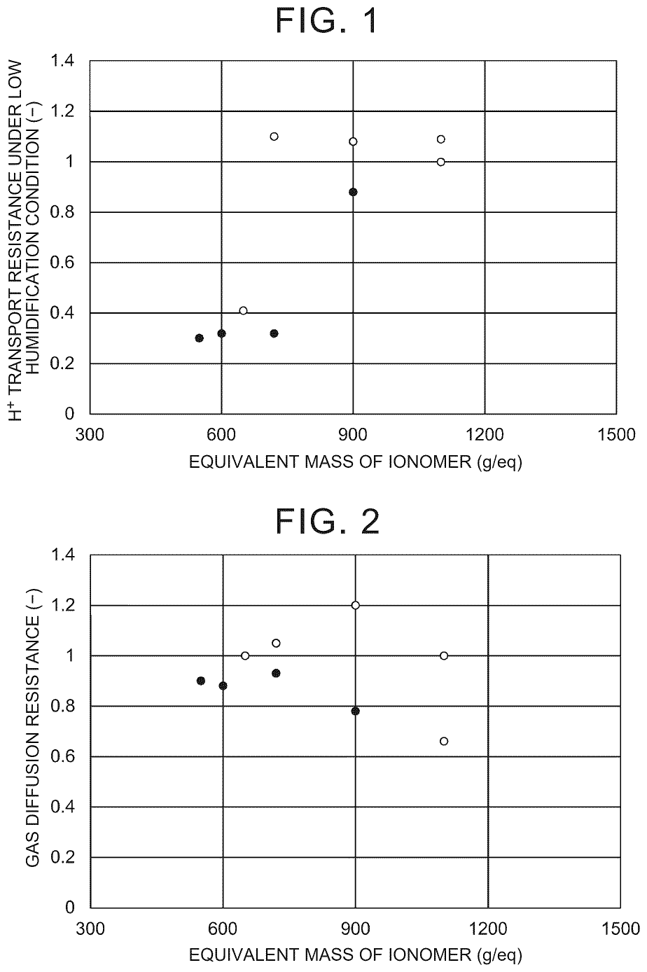

Tables 1 and 2 show the compositions of the ionomers of the examples and comparative examples and the evaluation results of the MEAs including the electrochemical oxygen reduction catalysts containing the ionomers. In Tables 1 and 2, the gas diffusion resistance, the H⁺ transport resistance under the high humidification condition, and the H⁺ transport resistance under the low humidification condition that are the electrochemical performance of the MEA are shown as relative values with the values of Comparative Example 1 set to 1.00. FIG. 1 shows the relationship between the equivalent mass of each of the ionomers of the examples and the comparative examples and the H⁺ transport resistance under the low humidification condition for each of the MEAs including the electrochemical oxygen reduction catalysts containing the ionomers. FIG. 2 shows the relationship between the equivalent mass of each of the ionomers of the examples and the comparative examples and the gas diffusion resistance of each of the MEAs including the electrochemical oxygen reduction catalysts containing the ionomers. In FIGS. 1 and 2, “◯” represents the values of Comparative Examples 1 to 5, and “●” represents the values of Examples 1 to 4. In FIG. 1, the horizontal axis represents the equivalent mass (g/eq) of the ionomer, and the vertical axis represents the H⁺ transport resistance (−) under the low humidification condition. The H⁺ transport resistance (−) under the low humidification condition is shown as a relative value with the value of Comparative Example 1 set to 1.00. In FIG. 2, the horizontal axis represents the equivalent mass (g/eq) of the ionomer, and the vertical axis represents the gas diffusion resistance (−). The gas diffusion resistance (−) is shown as a relative value with the value of Comparative Example 1 set to 1.00.

TABLE 1

| | | | | |
|---|---|---|---|---|
| Item | Example 1 | Example 2 | Example 3 | Example 4 |

Ionomer

| | | | | |
|---|---|---|---|---|
| Equivalent | 900 | 720 | 600 | 550 |
| mass (g/eq) | | | | |

Modifying layer

| | | | | |
|---|---|---|---|---|
| Number of | 6 | 6 | 6 | 6 |
| basic nitrogen | | | | |
| atoms in | | | | |
| nitrogen- | | | | |
| containing | | | | |
| cyclic organic | | | | |
| compound | | | | |
| Mass of | 3 | 3 | 3 | 3 |
| nitrogen- | | | | |
| containing | | | | |
| cyclic organic | | | | |
| compound with | | | | |
| respect to total | | | | |
| mass of | | | | |
| ionomer | | | | |
| (mass %) | | | | |
| Substance | 10 | 10 | 10 | 10 |
| amount of | | | | |
| nitrogen- | | | | |
| containing | | | | |
| cyclic organic | | | | |
| compound with | | | | |
| respect to total | | | | |
| substance | | | | |
| amount of | | | | |
| acidic | | | | |
| functional | | | | |
| group of | | | | |
| ionomer | | | | |
| (mol %) | | | | |

Electrochemical performance of MEA

| | | | | |
|---|---|---|---|---|
| Gas diffusion | 0.78 | 0.93 | 0.88 | 0.90 |
| resistance (—) | | | | |
| High | 0.97 | 0.18 | 0.26 | 0.16 |
| humidification | | | | |
| condition | | | | |
| H⁺ transport | | | | |
| resistance (—) | | | | |
| Low | 0.88 | 0.32 | 0.32 | 0.30 |
| humidification | | | | |
| condition | | | | |
| H⁺ transport | | | | |
| resistance (—) | | | | |
| Overall | ∘ | ∘ | ∘ | ∘ |
| evaluation | | | | |

TABLE 2

| | | | | | |
|---|---|---|---|---|---|
| | Comparative | Comparative | Comparative | Comparative | Comparative |
| Item | Example 1 | Example 2 | Example 3 | Example 4 | Example 5 |

Ionomer

| | | | | | |
|---|---|---|---|---|---|
| Equivalent | 1100 | 900 | 720 | 650 | 1100 |
| mass (EW) | | | | | |

Modifying layer

| | | | | | |
|---|---|---|---|---|---|
| Number of- | — | — | — | — | 6 |
| basic nitrogen | | | | | |
| atoms in | | | | | |
| nitrogen- | | | | | |
| containing | | | | | |
| cyclic organic | | | | | |
| compound | | | | | |
| Mass of | — | — | — | — | 3 |
| nitrogen- | | | | | |
| containing | | | | | |
| cyclic organic | | | | | |
| compound | | | | | |
| with respect to | | | | | |
| total mass of | | | | | |
| ionomer | | | | | |
| (mass %) | | | | | |
| Substance | — | — | — | — | 10 |
| amount of | | | | | |
| nitrogen- | | | | | |
| containing | | | | | |
| cyclic organic | | | | | |
| compound | | | | | |
| with respect to | | | | | |
| total | | | | | |
| substance | | | | | |
| amount of | | | | | |
| acidic | | | | | |
| functional | | | | | |
| group of | | | | | |
| ionomer | | | | | |
| (mol %) | | | | | |

Electrochemical performance of MEA

| | | | | | |
|---|---|---|---|---|---|
| Gas diffusion | 1.00 | 1.20 | 1.05 | 1.00 | 0.66 |
| resistance (—) | | | | | |
| High | 1.00 | 1.01 | 1.03 | 0.40 | 0.81 |
| humidificatio | | | | | |
| n condition | | | | | |
| H⁺ transport | | | | | |
| resistance (—) | | | | | |
| Low | 1.00 | 1.08 | 1.10 | 0.41 | 1.09 |
| humidificatio | | | | | |
| n condition | | | | | |
| H⁺ transport | | | | | |
| resistance (—) | | | | | |
| Overall | — | x | x | x | x |
| evaluation | | | | | |

Regarding the gas diffusibility of each of the MEAs including the electrochemical oxygen reduction catalysts containing the ionomers of the examples or the comparative examples, it was observed that the MEAs including the electrochemical oxygen reduction catalysts containing the ionomers with the modifying layers (Examples 1 to 4 and Comparative Example 5) had an effect of reducing the gas diffusion resistance compared to the MEAs including the electrochemical oxygen reduction catalysts containing the control ionomers without the modifying layers (Comparative Examples 1 to 4) (Tables 1 and 2 and FIG. 2).

Regarding the proton conductivity of each of the MEAs including the electrochemical oxygen reduction catalysts containing the ionomers of the examples or the comparative examples, the H⁺ transport resistance under the low humidification condition increased in the MEA including the electrochemical oxygen reduction catalyst containing the ionomer with the EW of 1100 and with the modifying layer in Comparative Example 5 compared to the MEA including the electrochemical oxygen reduction catalyst containing the ionomer with the same EW but without the modifying layer in Comparative Example 1 (Table 2 and FIG. 1). From this result, it is inferred that the nitrogen-containing cyclic organic compound, the polymer thereof, or the cation thereof contained in the modifying layer was bonded to the acidic functional group of the ionomer to inhibit the bond between water molecules and the acidic functional group, thereby preventing formation of hydrophilic clusters in the catalyst layer of the MEA, resulting in a decrease in proton conductivity.

In the MEAs including the electrochemical oxygen reduction catalysts containing the ionomers with the EWs of 1000 or less and with the modifying layers in Examples 1 to 4, the proton conductivity was improved compared to the MEA including the electrochemical oxygen reduction catalyst containing the ionomer with the same modifying layer but with the higher EW in Comparative Example 5 (Tables 1 and 2 and FIG. 1). The electrochemical oxygen reduction catalyst containing the ionomer with the modifying layer containing the nitrogen-containing organic compound is known to have high performance. It is considered that the proton conductivity is improved due to an interaction between the basic nitrogen atoms of the nitrogen-containing organic compound contained in the modifying layer and the interface of the catalytic metal, which attracts the ionomer closer to the catalytic metal, thereby increasing the coverage of the catalytic metal and the support with the ionomer. It is inferred that, in the MEA including the electrochemical oxygen reduction catalyst containing the ionomer of the present disclosure, the effect of improving the proton conductivity due to the increase in coverage of the catalytic metal and the support cause by the interaction between the interface of the catalytic metal and the basic nitrogen atoms of the nitrogen-containing cyclic organic compound, the polymer thereof, or the cation thereof contained in the modifying layer exceeded the effect of inhibiting the bond of the acidic functional group by the nitrogen-containing cyclic organic compound, the polymer thereof, or the cation thereof contained in the modifying layer, resulting in the improvement in proton conductivity.

The present disclosure is not limited to the above examples, and includes various modifications. For example, the above examples are described in detail for better understanding of the present disclosure, and the present disclosure is not necessarily limited to the one having all the illustrated configurations. It is also possible to add other configuration(s), delete, and/or replace part of the configurations of each example.

What is claimed is:

1. An ionomer comprising acidic functional groups and a modifying layer that modifies the acidic functional groups, wherein
the modifying layer contains a nitrogen-containing cyclic organic compound, a polymer of the nitrogen-containing cyclic organic compound, or a cation of the nitrogen-containing cyclic organic compound or the polymer, and
equivalent mass of the acidic functional groups is 1000 g/eq or less.

2. The ionomer according to claim 1, wherein the nitrogen-containing cyclic organic compound, the polymer of the nitrogen-containing cyclic organic compound, or the cation of the nitrogen-containing cyclic organic compound or the polymer is melamine, ammeline, ammelide, cyanuric acid, triazine, a derivative of the melamine, the ammeline, the ammelide, the cyanuric acid, or the triazine, a polymer of the melamine, the ammeline, the ammelide, the cyanuric acid, or the triazine, or a cation of the melamine, the ammeline, the ammelide, the cyanuric acid, the triazine, the derivative, or the polymer.

3. The ionomer according to claim 1, wherein the nitrogen-containing cyclic organic compound, the polymer of the nitrogen-containing cyclic organic compound, or the cation of the nitrogen-containing cyclic organic compound or the polymer is melamine.

4. The ionomer according to claim 1, wherein the acidic functional groups are bonded via a long-chain hydrocarbon group.

5. The ionomer according to claim 1, wherein the equivalent mass of the acidic functional groups is in a range of 550 g/eq to 900 g/eq.
